(19) United States
(12) Patent Application Publication
(10) Pub. No.: US 2017/0243569 A1
(43) Pub. Date: Aug. 24, 2017

(54) NEW-TYPE NATIVE AMERICAN FLUTE

(71) Applicant: Hongxiao ZHAO, Wuhan City (CN)

(72) Inventor: Hongxiao ZHAO, Wuhan City (CN)

(21) Appl. No.: 15/427,697

(22) Filed: Feb. 8, 2017

(30) Foreign Application Priority Data
Feb. 22, 2016 (CN) 201620134435.X
Apr. 25, 2016 (CN) 201620349484.5

(51) Int. Cl. G10D 7/02

(52) U.S. Cl. CPC G10D 7/026

(57) ABSTRACT

Disclosed is a new-type native American flute with a new finger hole design. One end of a flute head is provided with a mouthpiece, and the other end of the flute head is connected with a flute body. The front of the flute head is provided with a flute nose and a sound outlet. The flute body is provided with 7-10 finger holes. The finger holes may include main finger holes and an auxiliary finger hole, and the auxiliary finger hole is on the side of the main finger holes. The main finger holes include front main finger holes and a back main finger hole. Arranging an auxiliary finger hole on the surface of a native American flute in the present disclosure may broaden the range, increase altered tones as well, and further realize fine tuning for the altered tones.

### TECHNICAL FIELD

The present disclosure relates to the field of wind instrument and, more particularly, to a new-type native American flute.

### BACKGROUND

The traditional native American flute with fewer finger holes and complicated fingering arrangement does not conform to the playing habits of beginners and thus increases the learning curve for beginners. In addition, in the traditional nnative American flute, an air drain is directly arranged between an air chamber outlet and a sound hole, which is guided by a flute nose. Moreover, the inner diameters of a pipe chamber are of the same size. Such a structure with a narrow range may cause many wide range tracks unable to play. Thus, the existing native American flute has the following technical problems: on the one hand, the range is too narrow which leads to fewer tracks of playing. On the other hand, the fingering arrangement is complicated, which increases the learning curve for beginners.

### SUMMARY

An object of the present disclosure is to provide a new-type native American flute in order to solve the problems of narrow range and complicated fingering in a conventional native American flute.

In order to achieve the above object, the present disclosure provides a new-type native American flute which may include a flute head and a flute body. One end of the flute head is provided with a mouthpiece, and the other end of the flute head is connected with the flute body. The front of the flute head is provided with a flute nose and a sound outlet. The centerline of the flute nose and the centerline of the sound outlet are on the same line. The flute body may have 7-10 finger holes. The range of the native American flute is expanded through increasing the number of finger holes. Moreover, the current design with 6 finger holes of a native American flute is changed to make it possible for a player to control one or more finger holes with one finger, which meets the fingering habit of beginners and makes it easy to play.

In a preferred embodiment, the finger holes may include main finger holes and an auxiliary finger hole. The auxiliary finger hole is located on the side of the main finger holes. The main finger holes may include front main finger holes and a back main finger hole. By providing an auxiliary finger hole, the range can be further broadened and altered tones can be increased as well. Furthermore, fine tuning for the altered tones is realized.

In a preferred embodiment, the centerline of the front main finger holes and the centerline of the sound outlet are on the same line, and the centerline of the back main finger hole and the centerline of the front main finger holes are symmetrical along the axis of the flute body.

In a preferred embodiment, the back main finger hole is a thumb finger hole.

In a preferred embodiment, the front main finger holes comprise, in order, a left index finger hole, a left middle finger hole, a left ring finger hole, a right index finger hole, a right middle finger hole and a right ring finger hole along the direction from the flute head to the flute body, or the front main finger holes are, in order, a right index finger hole, a right middle finger hole, a right ring finger, a left index finger hole, a left middle finger hole and a left ring finger hole.

In a preferred embodiment, when the main finger hole located at the end of the front main finger holes is a right ring finger hole, the auxiliary finger hole is a right little auxiliary finger hole located on the right side of the right ring finger hole; and when the main finger hole located at the end of the front main finger hole is a left ring finger hole, the auxiliary finger hole is a left little auxiliary finger hole located on the left side of the left ring finger hole.

In a preferred embodiment, one end of the flute head connected to the flute body is a pipe orifice. The flute body is provided therein with a flute separator to form an air chamber between the mouthpiece and the flute separator and form a pipe chamber between the pipe orifice and the flute separator. The inner diameter of the pipe chamber is in a shape of an approximate horn, the inner diameter of the pipe chamber near the flute separator is greater than that of the pipe orifice. The pipe chamber in a shape of a horn may change the current structure with uniform inner diameter of the pipe chamber to allow the airflow flowing into the pipe chamber to be greater than the airflow flowing out of the pipe chamber, thus expanding the range of the native American flute, getting better music fluency, being able to play high pitch and low pitch and having high practicability.

In a preferred embodiment, the air chamber is provided with an air chamber outlet, the pipe chamber is provided with a sound hole, the bottom of the flute nose is provided with an air drain which is located outside the air chamber outlet and extends to the outside of the sound hole so as to draw the airflow in the air chamber into the sound hole via the flute nose. Provision of an air drain on the bottom of the flute nose may change the structure of the air drain being directly provided on the flute body in the current native American flute, avoid arranging an air drain on the flute body between the air chamber outlet and the sound hole, decrease the processing difficulty, and further raise the height of the air chamber outlet to increase airflow rising height.

In a preferred embodiment, the flute nose includes an upper portion and a hard plastic base. The air drain is located on the bottom of the hard plastic base. The surface of the flute body is provided with a nasal groove. Both the air chamber outlet and the sound hole are located in the nasal groove. The hard plastic base is fixed on the nasal groove by gluing. The hard plastic material has high weather resistance, not easy to corrode, and easy to be fixed on the surface of the flute body. The hard plastic base of the flute nose is easy to be fixed on the surface of the flute body by gluing, which may change the cord fixing mode of a traditional native American flute, and improve the stability of the tone and intonation of the present disclosure and will not lead to tone and intonation change due to the movement of the flute nose.

In a preferred embodiment, the top of the air chamber outlet is flush with the top of the sound hole. The air chamber outlet is rectangular, with its long side is consistent with the lengthwise direction of the flute body. The sound hole is rectangular, with its long side being perpendicular to the lengthwise direction of the flute body.

The beneficial effects of the present disclosure are as follows: the range of the native American flute is broadened through increasing the number of finger holes. By providing an auxiliary finger hole, the range is further expanded, the altered tones are increased and fine tuning to the altered tones is realized. The design with 7-10 finger holes can change the current design with 6 finger holes of a conventional native American flute to allow a player to control one or more finger holes with one finger so as to meet the fingering habit of beginners to make it easy to play and render a better music fluency. It can play high pitch and low pitch music, and has strong practicability.

### BRIEF DESCRIPTION OF THE DRAWINGS

In order to more clearly illustrate the technical solutions in the embodiments of the present invention or in the prior art, drawings to be used in the description of the embodiments or the prior art will be briefly introduced in the following. Apparently, the drawings in the following description are merely some embodiments of the present invention, and other drawings can be obtained by those skilled in the art based on these drawings without any inventive efforts.

FIG. 1 is a front view of a native American flute according to an embodiment of the present disclosure;

FIG. 2 is a back view of a native American flute according to an embodiment of the present disclosure;

FIG. 3 is a sectional view of a native American flute according to an embodiment of the present disclosure; and

FIG. 4 is a sectional view of the connection of a flute nose and a flute body of a native American flute according to an embodiment of the present disclosure.

### DETAILED DESCRIPTION

The following will clearly and completely describe the technical solutions of the disclosure with reference to the drawings. Obviously, the described embodiments are merely part of the embodiments of the disclosure, and do not encompass all possible embodiments. Based on the description provided in the disclosure, other embodiments obtained by those skilled in the art without any inventive efforts fall within the scope of the disclosure.

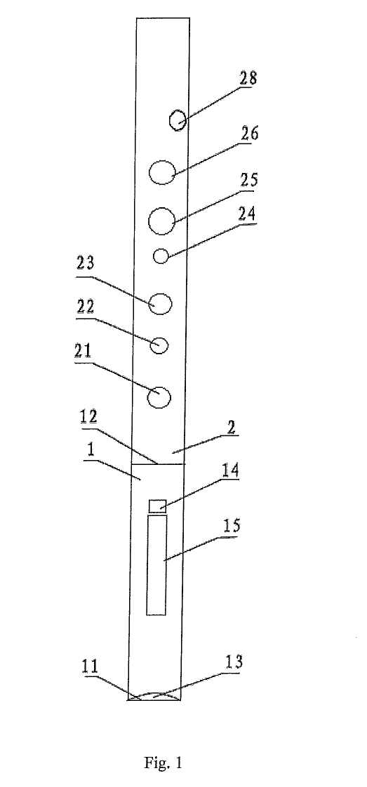

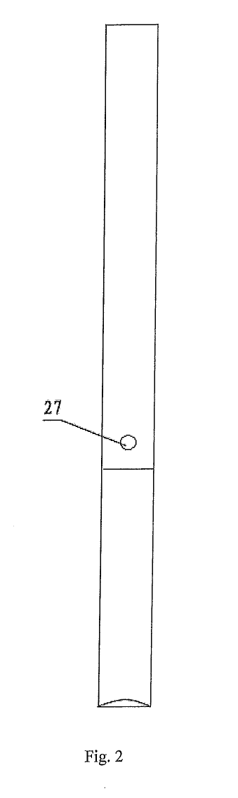

In an embodiment of the present disclosure, a new-type native American flute is provided. As shown in FIGS. 1-2, the new-type native American flute includes a flute head 1 and a flute body 2. The flute head 1 is cylindrical which is sealed at one end 11 and has a pipe orifice 12 at the other end. A mouthpiece 13 is provided in the middle of the sealed end 11. The pipe orifice 12 is connected with the flute body 2. The cross section of the mouthpiece 13 is round or similar round. The front of the flute head 1 is provided with a sound outlet 14 and a flute nose 15. The centerline of the sound outlet 14 and the centerline of the flute nose 15 are on the same line.

The flute body 2 is cylindrical with the same size of inner and outer diameters as the flute head 1. The flute head 1 and the flute body 2 can be made of wood, plastic, bamboo and other materials. The flute head 1 and the flute body 2 can be produced in an integrated molding way or through connection after being machined in segments. The connection can be realized with adhesion, thread, etc. The flute body 2 is provided with a row of main finger holes, including front main finger holes and a back main finger hole. The main finger holes comprise, in order, a left index finger hole 21, a left middle finger hole 22, a left ring finger hole 23, a right index finger hole 24, a right middle finger hole 25 and a right ring finger hole 26 along the direction from the flute head 1 to the flute body 2. The centerline of the front main finger holes and the centerline of the sound outlet 14 are overlapped. Providing an auxiliary finger hole on the side of the main finger holes can not only broaden the range, but also increase altered tones so as to make a fine tune on the temperament. The auxiliary finger hole is an auxiliary finger hole 28 for right little finger located on the right side of the right ring finger hole 26. The back main finger hole is a left thumb finger hole 27. The left thumb finger hole 27 is closer to the mouthpiece 13 than the left index finger hole 21. The centerline of the left thumb finger hole 27 and the centerline of the front main finger holes are symmetrical with each other along the axis of the flute body 2. Such an arrangement of finger holes can fit for the fingering habit of music lovers, and make the playing in this embodiment less difficult while better music fluency can be obtained.

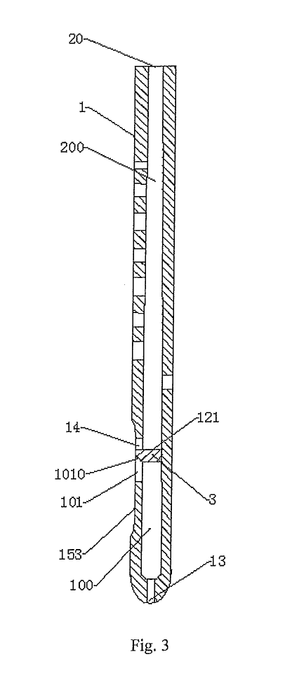

Referring to FIG. 3, a flute separator 3 is fixed inside the flute head 1, so that the flute separator 3 locates in the interior of the entire flute where it is at one-third of the entire flute's length (that is, the total length of the flute head 1 and the flute body 2). The interior of the entire flute is divided into two parts by the flute separator 3, one part being an air chamber 100 formed between the sealed end 11 and the flute separator 3, and the other part being a pipe chamber 200 formed between the flute separator 1 and the tail end of the flute body 20. The inner diameter of the pipe chamber 200 is shaped approximately like a horn. The inner diameter near the flute separator 3 is the largest and is gradually reduced to the direction of the pipe orifice 20 to form a micro horn shape. The pipe chamber 200 in a shape of a horn can make the airflow flowing into the pipe chamber 200 greater than the airflow flowing out of the pipe chamber 200, thus expanding the range of this embodiment.

The mouthpiece 13 is connected to the air chamber 100 through an inlet passage. On top of the air chamber 100 is arranged an air chamber outlet 101. The air chamber outlet 101 is rectangular, and its lengthwise direction is consistent with the lengthwise direction of the flute body 1. On top of the air chamber 100 is arranged a sound hole 14. The sound hole 14 is rectangular, and its lengthwise direction is perpendicular to the lengthwise direction of the flute body 1. The centerline of the sound hole 14 and the centerline of the air chamber outlet 101 are on the same line. The air chamber outlet 101 is closer to the mouthpiece 13 than the sound hole 14. The side wall of the air chamber outlet 101 near the sound hole 14 is a slope 1010, so that the airflow in the air chamber 10 may rise along the slope 1010.

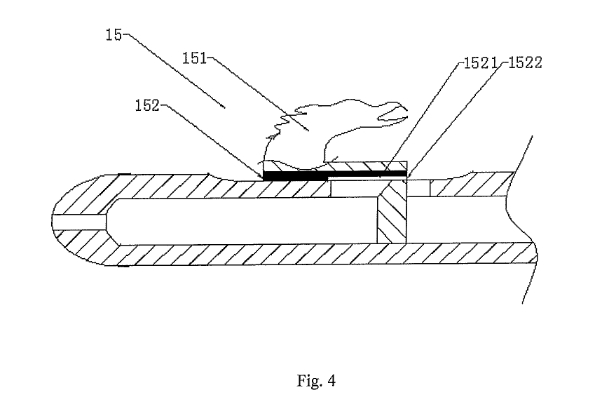

In order to make the rising airflow horizontally flow into the sound hole 14 from the air chamber outlet 101 to effectively control the scale during playing, the top of the air chamber outlet 101 is flush with the top of the sound hole 14. As shown in FIG. 4, the flute nose 15 includes an upper portion 151 and an acrylic base 152, and the upper portion 151 is bonded above the acrylic base 152 by gluing. An air drain 1521 is located on the bottom of the acrylic base 152. The air drain 1521 may extend along the bottom surface of the base 152. An air drain outlet 1522 is formed by joining the air drain 1521 with the side wall of the base 152. The acrylic base 152 is fixed outside the air chamber outlet 101 to make the air drain 1521 cover the outside of the whole air chamber outlet 101. The air drain outlet 1522 locates above the side wall of the sound hole 14 near the air chamber outlet 101. The airflow in the air chamber 100 is introduced into the sound hole 14 via the air drain 1521. Providing the air drain 1521 on the bottom of the flute nose 2 can increase the height of the air chamber outlet 101 to increase airflow rising height and expand the range of the native American flute. Therefore, the music fluency is good, high pitch and low pitch can be played and the practicability is high. The flute nose is fixed by a cord in a traditional native American flute and thus the interior airway of the flute may change due to the movement of the flute nose in use, which leads to tone and intonation change. In this embodiment, the bottom of the flute nose adopting the acrylic material as the base allows the flute nose to be fixed on the surface of the flute body by gluing so as to improve the stability of the tone and intonation. Furthermore, the acrylic material has high weather resistance and will not lead to the structure change of the air drain due to the environment and long-term use.

In an embodiment, the surface of the flute head is provided with a nasal groove 153 in order to facilitate the fixing of the flute nose 15 on the surface of the flute body 1. The bottom of the nasal groove 153 is a plane. Both the air chamber outlet 101 and the sound hole 14 locate in the nasal groove 153. The bottom of the flute nose 15 is a plane in order to fix the bottom of the flute nose 15 on the nasal groove 153.

Finally, it should be noted that, the above embodiments are provided to describe the technical solutions of the disclosure, but are not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure. As a result, the protection scope of the present invention shall be subject to the protection range of the claim.

What is claimed is:

1. A new-type native American flute comprising a flute head and a flute body, one end of the flute head being provided with a mouthpiece, the other end of the flute head being connected with the flute body, the front of the flute head being provided with a flute nose and a sound outlet, and the centerline of the flute nose and the centerline of the sound outlet being on the same line, characterized in that the flute body is provided with 7-10 finger holes.

2. The new-type native American flute of claim 1, wherein the finger holes include main finger holes and an auxiliary finger hole, the auxiliary finger hole being on the side of the main finger holes, the main finger holes including front main finger holes and a back main finger hole.

3. The new-type native American flute of claim 2, wherein the centerline of the front main finger holes and the centerline of the sound outlet are on the same line, and the centerline of the back main finger hole and the centerline of the front main finger holes are symmetrical along the axis of the flute body.

4. The new-type native American flute of claim 3, wherein the back main finger hole is a thumb finger hole.

5. The new-type native American flute of claim 2, wherein the front main finger holes comprise, in order, a left index finger hole, a left middle finger hole, a left ring finger hole, a right index finger hole, a right middle finger hole and a right ring finger hole, or a right index finger hole, a right middle finger hole, a right ring finger, a left index finger hole, a left middle finger hole and a left ring finger hole along the direction from the flute head to the flute body.

6. The new-type native American flute of claim 5, wherein when the main finger hole provided at the end of the front main finger holes is a right ring finger hole, the auxiliary finger hole is a right little auxiliary finger hole located on the right side of the right ring finger hole; and when the main finger hole located at the end of the front main finger holes is a left ring finger hole, the auxiliary finger hole is a left little auxiliary finger hole located on the left side of the left ring finger hole.

7. The new-type native American flute of claim 1, wherein one end of the flute head connected to the flute body is a pipe orifice, the flute body being provided therein with a flute separator to form an air chamber between the mouthpiece and the flute separator and form a pipe chamber between the pipe orifice and the flute separator, the inner diameter of the pipe chamber being of an approximate horn shape, and the inner diameter of the pipe chamber near the flute separator being greater than the that of the pipe orifice.

8. The new-type native American flute of claim 7, wherein the air chamber is provided with an air chamber outlet, the pipe chamber is provided with a sound hole, and the bottom of the flute nose is provided with an air drain, the air drain being located outside the air chamber outlet, and the air drain extending to the outside of the sound hole so as to draw the airflow in the air chamber into the sound hole via the flute nose.

9. The new-type native American flute of claim 8, wherein the flute nose includes an upper portion and a hard plastic base, the air drain being located on the bottom of the hard plastic base, the surface of the flute body being provided with a nasal groove, both the air chamber outlet and the sound hole being provided in the nasal groove, and the hard plastic base being fixed on the nasal groove by gluing.

10. The new-type native American flute of claim 8, wherein the top of the air chamber outlet is flush with the top of the sound hole, the air chamber outlet being rectangular, and its lengthwise direction being consistent with the lengthwise direction of the flute body; and the sound hole being rectangular, and its lengthwise direction being perpendicular to the lengthwise direction of the flute body.

11. The new-type native American flute of claim 4, wherein the front main finger holes are, in order, a left index finger hole, a left middle finger hole, a left ring finger hole, a right index finger hole, a right middle finger hole and a right ring finger hole, or a right index finger hole, a right middle finger hole, a right ring finger, a left index finger hole, a left middle finger hole and a left ring finger hole along the direction from the flute head to the flute body.

12. The new-type native American flute of claim 11, wherein when the main finger hole provided at the end of the front main finger holes is a right ring finger hole, the auxiliary finger hole is a right little auxiliary finger hole located on the right side of the right ring finger hole; and when the main finger hole located at the end of the front main finger holes is a left ring finger hole, the auxiliary finger hole is a left little auxiliary finger hole located on the left side of the left ring finger hole.

13. The new-type native American flute of claim 2, wherein one end of the flute head connected to the flute body is a pipe orifice, the flute body being provided therein with a flute separator to form an air chamber between the mouthpiece and the flute separator and form a pipe chamber between the pipe orifice and the flute separator, the inner diameter of the pipe chamber being of an approximate horn shape, and the inner diameter of the pipe chamber near the flute separator being greater than the that of the pipe orifice.

14. The new-type native American flute of claim 4, wherein one end of the flute head connected to the flute body is a pipe orifice, the flute body being provided therein with a flute separator to form an air chamber between the mouthpiece and the flute separator and form a pipe chamber between the pipe orifice and the flute separator, the inner diameter of the pipe chamber being of an approximate horn shape, and the inner diameter of the pipe chamber near the flute separator being greater than the that of the pipe orifice.

15. The new-type native American flute of claim 6, wherein one end of the flute head connected to the flute body is a pipe orifice, the flute body being provided therein with a flute separator to form an air chamber between the mouthpiece and the flute separator and form a pipe chamber between the pipe orifice and the flute separator, the inner diameter of the pipe chamber being of an approximate horn shape, and the inner diameter of the pipe chamber near the flute separator being greater than the that of the pipe orifice.

16. The new-type native American flute of claim 12, wherein one end of the flute head connected to the flute body is a pipe orifice, the flute body being provided therein with a flute separator to form an air chamber between the mouthpiece and the flute separator and form a pipe chamber between the pipe orifice and the flute separator, the inner diameter of the pipe chamber being of an approximate horn shape, and the inner diameter of the pipe chamber near the flute separator being greater than the that of the pipe orifice.

17. The new-type native American flute of claim 13, wherein the air chamber is provided with an air chamber outlet, the pipe chamber is provided with a sound hole, and the bottom of the flute nose is provided with an air drain, the air drain being located outside the air chamber outlet, and the air drain extending to the outside of the sound hole so as to draw the airflow in the air chamber into the sound hole via the flute nose.

18. The new-type native American flute of claim 17, wherein the flute nose includes an upper portion and a hard plastic base, the air drain being located on the bottom of the hard plastic base, the surface of the flute body being provided with a nasal groove, both the air chamber outlet and the sound hole being provided in the nasal groove, and the hard plastic base being fixed on the nasal groove by gluing.

19. The new-type native American flute of claim 18, wherein the top of the air chamber outlet is flush with the top of the sound hole, the air chamber outlet being rectangular, and its lengthwise direction being consistent with the lengthwise direction of the flute body; and the sound hole being rectangular, and its lengthwise direction being perpendicular to the lengthwise direction of the flute body.

20. The new-type native American flute of claim 9, wherein the top of the air chamber outlet is flush with the top of the sound hole, the air chamber outlet being rectangular, and its lengthwise direction being consistent with the lengthwise direction of the flute body; and the sound hole being rectangular, and its lengthwise direction being perpendicular to the lengthwise direction of the flute body.
